(19) United States
(12) Patent Application Publication
(10) Pub. No.: US 2007/0167273 A1
(43) Pub. Date: Jul. 19, 2007

(54) Reverse spinning wheel cover

(75) Inventor: Michael A. Quesenberry, White Lake, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/332,109

(22) Filed: Jan. 13, 2006

(51) Int. Cl. F16H 57/08

(52) U.S. Cl. 475/331

(57) ABSTRACT

A wheel cover assembly adapted to be attached to a motor vehicle wheel. The wheel cover assembly includes a wheel cover and a mechanism operative in response to rotation of the wheel to rotate the wheel cover in a direction opposite to the direction of wheel rotation.

### FIELD OF THE INVENTION

This invention relates to wheel covers and more particularly to wheel covers that are capable of spinning relative to the associated wheel.

### BACKGROUND

Wheel covers and caps can be attached to exposed automobile wheel hubs for a variety of reasons including, but not limited to, aesthetic enhancement and providing an opportunity to identify the brand of the automotive vehicle. There has been a desire to provide dynamic wheel covers with various spinners and the like to enhance the aesthetic appeal of the wheels and associated vehicle through movement, perceived movement, and optical illusion. Heretofore the speed, direction and/or momentum of such spinners has been limited.

### SUMMARY

Disclosed herein is a wheel cover assembly adapted to be connected to a motor vehicle wheel. The wheel cover assembly includes a wheel cover and a mechanism operative in response to rotation of the wheel to rotate the wheel cover in a direction opposite to the direction of the rotation of the wheel. The mechanism may include a ring gear connected to the wheel cover and at least one gear operatively connected to the ring gear and impeded by at least one impedance device.

### BRIEF DESCRIPTION OF THE DRAWINGS

The description herein makes reference to the accompanying drawings wherein like reference numerals refer to like parts throughout the several views, and wherein:

FIG. 1 is a perspective view of a wheel cover assembly according to an embodiment disclosed herein shown in association with a motor vehicle wheel;

FIG. 2 is a cross sectional view taken on line 2-2 of FIG. 1;

FIG. 3 is a perspective exploded view of the wheel cover assembly of FIG. 1;

FIG. 4 is a fragmentary diagrammatic view showing the operation of the wheel cover assembly of FIG. 1;

FIGS. 5 and 6 are detail views showing components of the wheel cover assembly of FIG. 1;

FIG. 7 is an elevational view showing an alternate embodiment of the wheel cover assembly disclosed herein; and

FIG. 8 is a cross-sectional view taken on line 8-8 of FIG. 7.

### DETAILED DESCRIPTION

Disclosed herein is a wheel cover assembly adapted to be attached to a motor vehicle wheel. The wheel cover assembly includes a wheel cover and a mechanism operative in response to the rotation of the wheel to rotate the wheel in a direction opposite the direction of the rotation of the motor vehicle wheel. The mechanism operative in response to wheel rotation may include a ring gear fixed to the wheel cover and at least one intermediate gear intermeshed with the ring gear and connected to the motor vehicle wheel. The mechanism may also include at least one movement impedance device connected to the intermediate gear. The movement impedance device regulates planetary movement of the intermediate gear relative to the ring gear.

The mechanism operative in response to wheel rotation may include a planetary gear assembly including a sun gear, a planet gear or gears, in addition to the ring gear. A ballast can be connected to the planetary gear assembly so that the planetary gear assembly operates to rotate the wheel cover in response to rotation of the wheel with cover rotation proceeding in a direction opposed to wheel rotation. The ballast can be configured to impede planetary movement of the planet gear or gears about the sun gear. The wheel cover assembly can include a carrier plate interconnecting the planet gears and the ballast operative to anchor the carrier plate to preclude orbiting of the planet gear or gears about the sun gear in response to rotation of the sun gear by the wheel. This generates rotation of the ring gear and the wheel cover in a direction opposite to the direction of wheel rotation. Where desired or required the carrier plate may comprise a unitary plate member mounting a plurality of pivot shafts journaling the planet gears.

The planetary gear assembly as disclosed herein can further include a central shaft aligned with the central axis of the wheel. The sun gear can be fixedly mounted on the central shaft; and the carrier plate can be journaled on the central shaft. The wheel cover can also be journaled on the central shaft. The ring gear may be defined by an internally geared ring member.

The wheel cover may include a central hub journaled on the central shaft and a plurality of circumferentially spaced spokes emanating from the central hub.

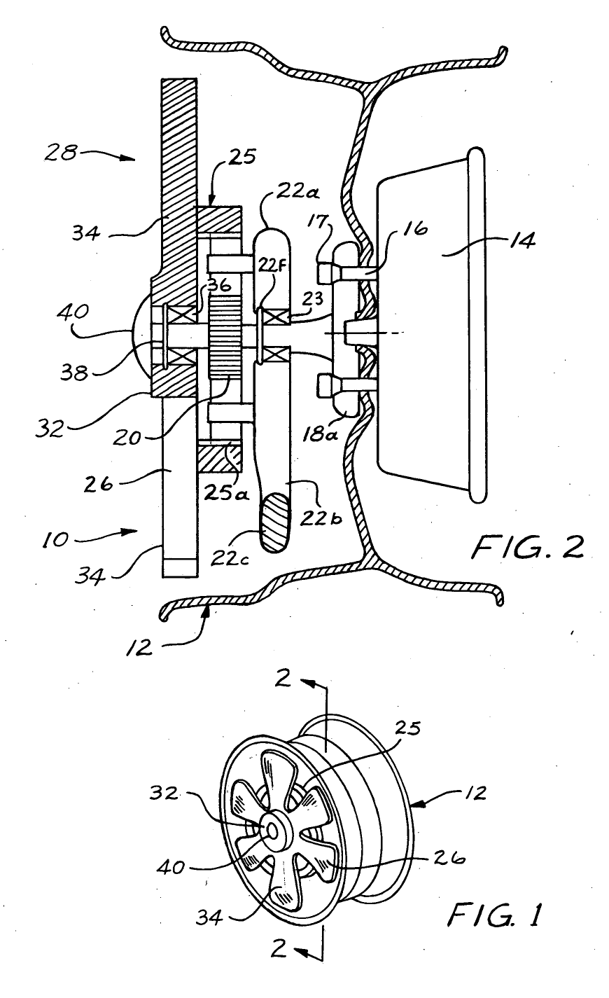

One embodiment of a wheel cover assembly 10 as disclosed herein is depicted in FIGS. 1 and 2 in association with a motor vehicle wheel 12. Motor vehicle wheel 12 can be mounted in known manner on a vehicle hub 14 in any suitable manner. As depicted in FIG. 2, circumferentially spaced studs 16 co-act with cap nuts 17 to fasten motor vehicle wheel to hub 14.

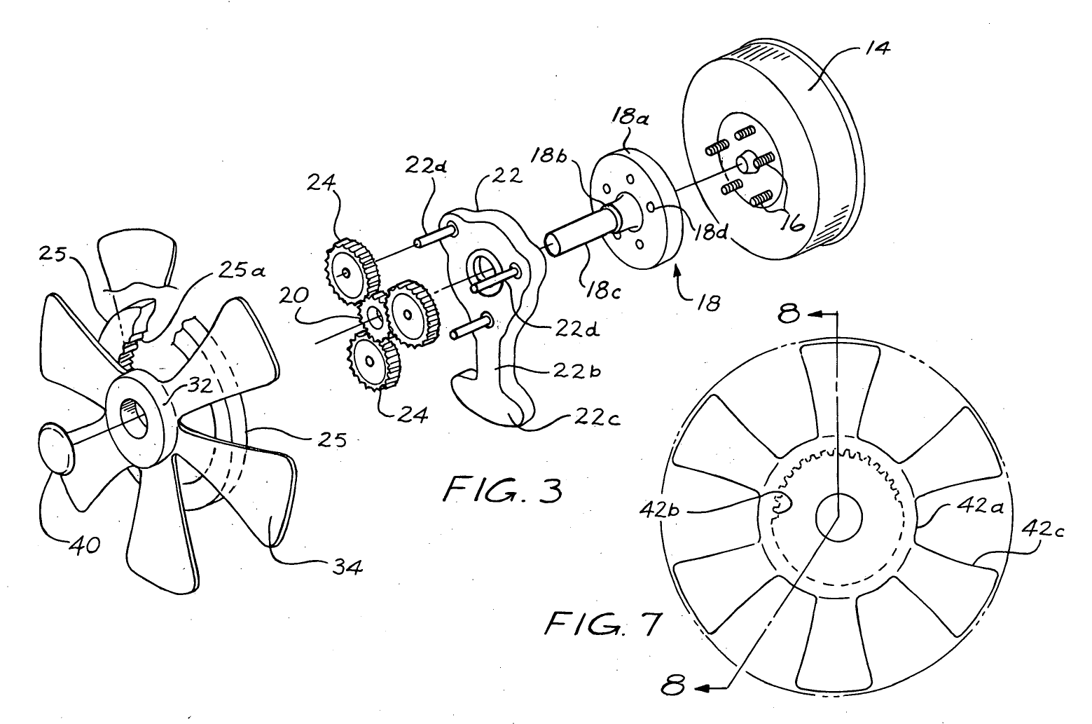

As seen in FIG. 3, wheel cover assembly 10, broadly considered, includes an attachment plate 18, a sun gear 20, a planet carrier plate 22, planet gears 24, a ring gear 25 and a wheel cover 26. Attachment plate 18 is configured to be mounted to vehicle hub 14. As depicted, the attachment plate 18 and wheel 12 can be mounted to vehicle hub 14 by studs 16 and associated cup nuts 17. As depicted, attachment plate 18 includes a circular base portion 18a, a hub portion 18b and a shaft portion 18c. A plurality of circumferentially spaced apertures 18d are provided in base portion 18a for receipt of studs 16. When mounted on vehicle hub 14, attachment plate 18 is configured such that shaft 18c projects centrally outward to receive carrier plate 22.

As depicted in FIGS. 3 and 6, carrier plate 22 includes a main body carrier portion 22a of generally triangular configuration, a radial arm portion 22b, a weight or ballast portion 22c at the free end of radial arm portion 22b, and a plurality of planet shafts 22d positioned in circumferentially spaced relation about a central aperture 22e. Carrier plate 22 is journaled on attachment plate shaft 18c via a bearing 23 and is precluded from axial movement relative to the shaft via a clip 22f.

Sun gear 20 is fixedly secured on shaft 18c outboard of planet carrier plate 22. A planet gear 24 is journaled on each planet shaft 22d and meshingly engages sun gear 20.

Ring gear 25 defines gear teeth 25a meshingly engaging the outer peripheries of planet gears 24.

Wheel cover 26 includes a central hub portion 32 and an outer portion such as a plurality of circumferentially spaced radially extending spokes 34 extending radially outwardly from hub 32. Wheel cover 26 is fixedly secured to ring gear 25. In the configuration depicted in the drawing figures, it is contemplated that one or more radially extending spokes 34 are secured to ring gear 25. Hub portion 32 is journaled on the outboard end of attachment plate shaft 18c via a bearing 36 and is precluded from axial movement relative to the shaft by a clip 38. A cap 40 secured to the outboard end of shaft of 18c cosmetically completes the wheel assembly.

The wheel cover assembly is mounted on vehicle hub 14 by removing cap nuts 17, passing the apertures 18d in attachment plate 18 over respective studs 16, and reinstalling cap nuts 17.

In operation, wheel cover 26 is rotated in a direction opposite to the direction of rotation of the wheel. As depicted in FIG. 4, wheel 12 rotates forwardly, sun gear 20 rotates forwardly in the direction of arrow A and is in meshing engagement with planet gears 24, which rotate in the direction of arrow B. However, since the planet gears are precluded from orbital or planetary movement about the sun gear by virtue of the weight or ballast 22c, ring gear 25 and associated wheel cover 26 are caused to rotate in a direction opposite to the direction of wheel movement designated by arrow C.

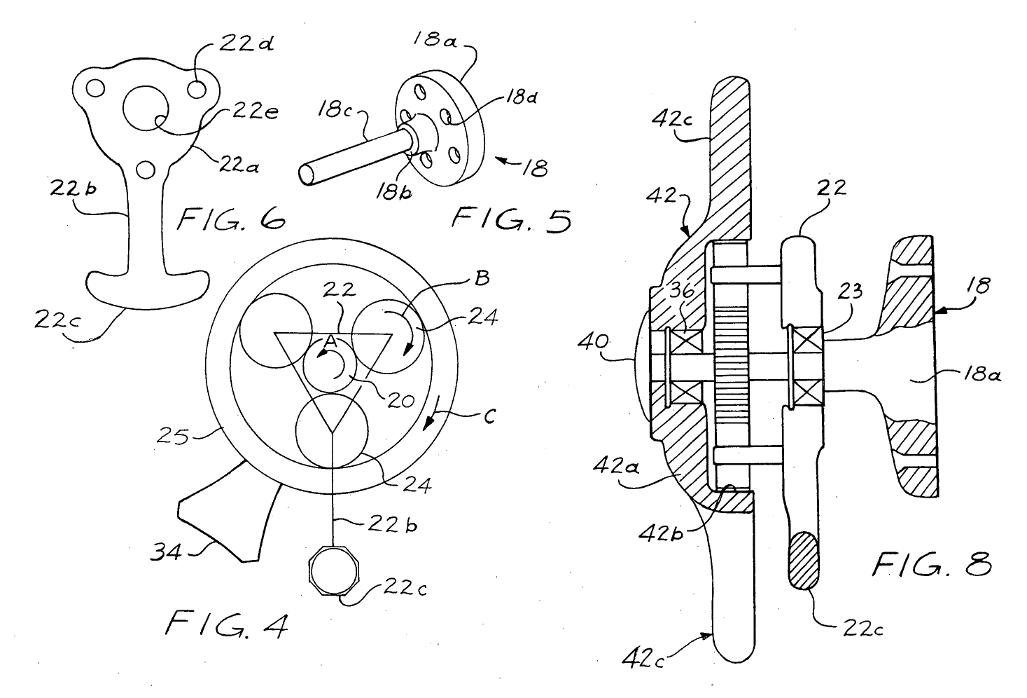

The wheel cover assembly seen in the alternate embodiment of FIGS. 7 and 8 is generally similar to the wheel cover assembly embodiment seen in FIGS. 1-6 with the exception that the wheel cover, rather than being formed of a separate ring gear secured to separate spokes, is formed as a unitary member 42 including a central body portion 42a journaled on the free end of shaft 18c of the attachment plate 18. Unitary member 42 also includes internal teeth 42b on the inboard face of the central hub portion 42a defining the ring gear, as well as spoke portions 42c extending radially outwardly from central hub 42a.

The wheel cover disclosed herein provides a simple and inexpensive way of creating a striking visual effect at each wheel of the vehicle with the wheel cover rotating rearwardly in response to the forward movement of the vehicle and forwardly in response to rearward movement of the vehicle.

It is contemplated that rotational speed of the wheel cover 26 can be varied by selective variation of the sizes of the sun, planet, and ring gears. One nonlimiting example of an effective combination incorporates a one inch (1″) diameter sun gear, two inch (2″) diameter planet gears, and a five inch (5″) inside diameter ring gear, Providing a five to one reduction ratio of the wheel cover rotational speed as compared to the rotational speed of the associated wheel. Other suitable reduction ratios can be utilized herein.

It is also contemplated that the device disclosed herein can be configured as a motor vehicle wheel assembly 28 that generally includes wheel rim 12 having a central aperture and a plurality of mounting apertures around the central aperture and a carrier plate 22 attached to the wheel rim 12. The rim 12 and counterplate 22 can be configured to receive studs on the hub plate 22 and include a wheel cover 26 and a mechanism to rotate the wheel cover in a direction opposed to rotation of the motor vehicle wheel.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A wheel cover assembly adapted to be connected to a motor vehicle wheel, the wheel cover assembly comprising:
a wheel cover; and
a mechanism connected to the wheel cover, the mechanism operative in response to rotation of the motor vehicle wheel to rotate the wheel cover in a direction opposite to the direction of rotation of the motor vehicle wheel.

2. The wheel cover assembly of claim 1, wherein the mechanism comprises:
a ring gear fixed to the wheel cover;
at least one intermediate gear intermeshed with the ring gear and adapted to be connected to the motor vehicle wheel; and
at least one movement impedance device connected to the intermediate gear, the movement impedance device regulating movement of the intermediate gear relative to the ring gear.

3. The wheel cover assembly of claim 1, wherein the mechanism comprises:
a planetary gear assembly connected to the wheel cover and adapted to be connected to the motor vehicle wheel; and
a ballast connected to the planetary gear assembly.

4. The wheel cover assembly of claim 3, wherein the planetary gear assembly comprises:
a sun gear;
at least one planetary gear engaging the sun gear; and
a ring gear engaging the planetary gear; wherein the ballast impedes movement of the planetary gear about the sun gear.

5. The wheel cover assembly of claim 4, wherein the planetary gear assembly further comprises a carrier plate, and wherein the carrier plate rotatably carries the planet gear and wherein the ballast is connected to the carrier plate.

6. The wheel cover assembly of claim 5, wherein the carrier plate includes at least one shaft projecting from the carrier plate to journal the planetary gear thereon.

7. A wheel cover assembly adapted to be connected to a motor vehicle wheel, the assembly including:
a sun gear adapted to be secured to the motor vehicle wheel for rotation with the motor vehicle wheel;
at least one planet gear arranged about and engaging the sun gear;
a ring gear engaging the planet gear;
a wheel cover fixed to the ring gear;
a carrier plate connected to the planet gear; and
a ballast connected to the carrier plate and operative to anchor the carrier plate to resist orbiting of the planet gear about the sun in response to rotation of the sun gear by the motor vehicle wheel thereby generating rotation of the ring gear and the wheel cover in a direction opposite to direction of wheel rotation.

8. The wheel cover assembly of claim 7, wherein the carrier plate includes at least one planet shaft journaling the least one planet gear.

9. The wheel cover assembly of claim 8, wherein:
the carrier plate includes a main body, wherein the planet shaft is mounted to the main body; and
the ballast includes an arm extending from the main body of the carrier plate and a mass at the free end of the arm.

10. The wheel cover assembly of claim 7, wherein the assembly includes a central shaft aligned with the central axis of the motor vehicle wheel, and wherein the sun gear is mounted on the central shaft; and wherein the carrier plate is journaled on the central shaft.

11. The wheel cover assembly of claim 10, wherein the wheel cover is journaled on the central shaft.

12. The wheel cover assembly of claim 10, wherein the wheel cover comprises a central body portion journaled on the free end of the central shaft and a plurality of circumferentially spaced spokes emanating from the central body portion.

13. The wheel cover assembly of claim 7, wherein the ring gear is defined by an internally geared ring member, and the wheel cover is fixed to the ring member.

14. A vehicle comprising:
a wheel including a wheel rim mounted on a hub, the wheel rim having a central body and a plurality of mounting apertures positioned around the central body;
a carrier plate having a plurality of mounting apertures corresponding to the mounting apertures in the wheel rim central body, wherein the wheel rim central body apertures and the carrier plate apertures are configured to receive studs positioned on the hub; and
a wheel cover assembly rotatably connected to the carrier plate, the wheel cover assembly including a wheel cover and a mechanism connected to the wheel cover, the mechanism being operative in response to rotation of the wheel to rotate the wheel cover in a direction opposite to the direction of rotation of the wheel.

15. The vehicle of claim 14, wherein the mechanism comprises:
a planetary gear assembly interconnecting the wheel and the wheel cover; and
a ballast connected to the planetary gear assembly.

16. The vehicle of claim 15, wherein the planetary gear assembly comprises:
a sun gear;
at least one planetary gear engaging the sun gear; and
a ring gear engaging the planetary gear; wherein the ballast impedes movement of the planetary gear about the sun gear.

17. A method for spinning a cover of a vehicle's wheel, comprising:
rotating the vehicle's wheel in a first direction; and
rotating the wheel cover in a direction opposite to the first direction.
